(19) United States
(12) Patent Application Publication
(10) Pub. No.: US 2026/0176777 A1
(43) Pub. Date: Jun. 25, 2026

(54) FLOW FIELDS FOR ENHANCING FLUID TRANSPORT IN ELECTROCHEMICAL CELLS

(71) Applicant: ELECTRIC HYDROGEN CO., Devens, MA (US)

(72) Inventors: Elif Karatay, Mountain View, CA (US); David Eaglesham, Lexington, MA (US)

(21) Appl. No.: 19/125,860

(22) PCT Filed: Dec. 11, 2023
(86) PCT No.: PCT/US2023/083324

§ 371 Date: Apr. 30, 2025

Related U.S. Application Data
(60) Provisional application No. 63/432,198, filed on Dec. 13, 2022.

(51) Int. Cl. C25B 9/19; C25B 1/04; H01M 8/026

(52) U.S. Cl. CPC C25B 9/19; C25B 1/04; H01M 8/026

(57) ABSTRACT

The following disclosure relates to electrochemical or electrolysis cells and components thereof, specifically to flow fields and dead-end inlet and outlet channel configurations within flow fields. In one example, the flow field may include at least one dead-end inlet channel and at least one dead-end outlet channel, wherein the dead-end inlet channel does not extend an entire length from the inlet to the outlet of the flow field and therein does not provide a direct fluid connection with the outlet, and wherein the dead-end outlet channel does not extend an entire length from the inlet to the outlet of the flow field and therein does not provide a direct fluid connection with the inlet.

This application claims the benefit of U.S. Provisional Patent Application No. 63/432,198, filed Dec. 13, 2022, which is hereby incorporated by reference in its entirety.

### FIELD

The following disclosure relates to electrochemical or electrolysis cells and components thereof. More specifically, the following disclosure relates to flow field configurations for improving or enhancing fluid transport within the electrochemical cells.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive the installation of electrolyzer systems.

Porous transport layers (PTLs) and gas diffusion layers (GDLs) play important roles in electrochemical cell performance. A PTL, positioned between an anode catalyst layer and an anode flow field of the electrochemical cell, may assist in transporting water and oxygen on the anode side and in transporting electrons away from the anode catalyst layer. A GDL, positioned between a cathode catalyst layer and a cathode flow field of the electrochemical cell, may assist in transporting hydrogen on the cathode side of the cell and in transporting electrons towards the cathode catalyst layer.

Inefficiencies with fluid transport within the electrochemical cell or stack may lead to undesirable heat generation within the cell. Heat generation at the membrane is particularly undesirable, specifically for thin membranes. Conventional solutions to mitigate heat generation include flowing water to both the anode and cathode sides of the cell to leverage a “heat exchanger”-type design. Alternative solutions include pin type flow fields, mesh type flow fields, serpentine channels, and so on. These flow field types rely on permeation of water across the PTL and GDL. While these solutions exist, there are challenges or undesirable problems created by such heat mitigation solutions, such as the increased volume of water needed to be supplied to the cell/stack and separated in the product streams from the cell/stack.

As such, there remains a desire for improved performance properties within electrochemical cells, including improved fluid transport within the cell.

### SUMMARY

In one embodiment, a flow field for an electrochemical cell is provided. The flow field includes an inlet configured to receive water; a plurality of inlet channels, each inlet channel connected to the inlet and configured to transfer water from the inlet to an adjacent layer of the electrochemical cell; an outlet configured to transfer fluids out of the electrochemical cell; a plurality of outlet channels, each outlet channel connected to the outlet and configured to transfer the fluids from the adjacent layer of the electrochemical cell to the outlet; and a plurality of lands, each land separating a channel of the plurality of inlet channels and the plurality of outlet channels from an additional channel of the plurality of inlet channels and the plurality of outlet channels. In the flow field, at least one inlet channel of the plurality of inlet channels includes a dead-end such that the at least one inlet channel does not extend an entire length from the inlet to the outlet of the flow field and therein does not provide a direct fluid connection with the outlet. Additionally, at least one outlet channel of the plurality of outlet channels includes a dead-end such that the at least one outlet channel does not extend the entire length from the inlet to the outlet of the flow field and therein does not provide a direct fluid connection with the inlet.

In another embodiment, an electrochemical cell is provided that includes a flow field; a membrane; and a porous transport layer or a gas diffusion layer positioned between the flow field and the membrane. Within the cell, the flow field includes: an inlet configured to receive water; a plurality of inlet channels, each inlet channel connected to the inlet and configured to transfer water from the inlet to the porous transport layer or the gas diffusion layer; an outlet configured to transfer fluids out of the electrochemical cell; a plurality of outlet channels, each outlet channel connected to the outlet and configured to transfer the fluids from the porous transport layer or the gas diffusion layer to the outlet; and a plurality of lands, each land separating a channel of the plurality of inlet channels and the plurality of outlet channels from an additional channel of the plurality of inlet channels and the plurality of outlet channels. In the flow field, at least one inlet channel of the plurality of inlet channels includes a dead-end such that the at least one inlet channel does not extend an entire length from the inlet to the outlet of the flow field and therein does not provide a direct fluid connection with the outlet. Additionally, at least one outlet channel of the plurality of outlet channels includes a dead-end such that the at least one outlet channel does not extend the entire length from the inlet to the outlet of the flow field and therein does not provide a direct fluid connection with the inlet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1A depicts an electrochemical stack having a plurality of electrochemical cells.

FIG. 1B depicts an example of an electrochemical cell.

FIG. 2 depicts an additional example of an electrochemical cell.

FIGS. 3A, 3B, and 3C depict cross-sectional views of an exemplary electrochemical cell with a limited number of flow channels of flow fields depicted for clarity.

FIGS. 4A and 4B depict a side view and a top view, respectively, of portion of such an electrode flow field having a limited number of flow channels and lands depicted for clarity.

FIG. 5 depicts a top view of a portion of an electrode flow field having a limited number of flow channels and lands depicted for clarity, wherein each channel is a dead-end inlet channel or a dead-end outlet channel.

FIG. 6 depicts a projection view of an additional embodiment of an improved flow field configuration having dead-end inlet and dead-end outlet channels.

FIG. 7 depicts an example of fluid flow velocities through the dead-end inlet and outlet channels based on the flow field configuration exemplified in FIG. 6.

FIG. 8 depicts an example of fluid flow velocities and temperature distribution within various flow field channels and an adjacent cell layer.

FIG. 9 depicts a comparison between fluid flow velocities within the porous transport layer located under dead-end channel configuration versus the conventional state-of-the-art regular channel arrangement without dead-ends.

### DETAILED DESCRIPTION

The following disclosure provides reconfigured flow fields within an electrochemical or electrolytic cell for improved fluid transport within the cell. Through the flow field configurations disclosed herein, water may advantageously be forced to travel into an adjacent porous layer (e.g., the PTL or GDL) of the cell instead of directly from the inlet to the outlet of the flow field without flowing into the adjacent layer. Additionally, the flow field configurations may advantageously generate a pressure build-up on the inlet side that forces or helps redirect the flow of the water into the adjacent porous layer, while the outlet side of the flow field may be open to atmospheric pressure conditions or controlled at a certain back pressure. Further, the flow field configurations may advantageously increase a velocity of water within the porous layer in comparison with a conventional flow field configuration under similar operating conditions, therein providing an improved forced convection. Such convective flow with the porous layer may also advantageously aid in the removal of generated gas and replenish the membrane with water at the operating temperature, thereby enhancing heat removal. Additional advantages of the flow field configurations may include that less water flow may be needed for the same performance output and for heat removal. That is, the stoic ratio between water flow and operating current within the electrochemical cell may be lowered while still being able to maintain the operating efficiency of the cell (e.g., removal of the generated hydrogen and oxygen gases from the water splitting reaction). This advantageously allows for the downsizing of downstream equipment needed to separate the water and gases produced within the electrochemical cell. For example, a smaller gas-liquid separator would be needed to separate the water and oxygen gas produced on the anode side of the cell. Additionally, a smaller gas-liquid separator would be required on the cathode side of the cell to separate hydrogen gas and water. These smaller separators, piping, pumps, etc. result in smaller operating costs in comparison to a similarly sized electrochemical cell/stack without the improved flow fields described herein.

### Electrochemical Cells and Systems

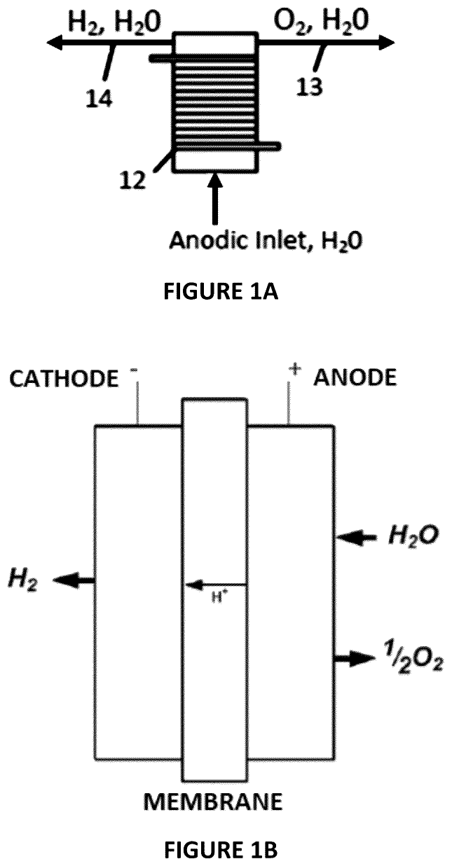

FIG. 1A depicts an example of an electrochemical system including an electrochemical stack having a plurality of electrochemical cells. In certain examples, the electrochemical stack may contain 50-1000 cells, 50-100 cells, 500-700 cells, or more than 1000 cells. Any number of cells may make up a stack. The electrochemical cells within the electrochemical stack may be configured to operate with 200 mV or less of pure resistive loss when operating at a high current density (e.g., at least 3 Amps/cm² , at least 4 Amps/cm², at least 5 Amps/cm², at least 6 Amps/cm², at least 7 Amps/cm², at least 8 Amps/cm², at least 9 Amps/cm², at least 10 Amps/cm², at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-5 mL/Amp/cell/min.

As illustrated in the system of FIG. 1A, water (H₂O) may be supplied to the anodic inlet of an electrolytic cell stack 12. In some embodiments, only the anodic inlet of the cell stack 12 may receive water. In these embodiments, the cathode side of the cell stack 12 may not receive water (e.g., a dry cathode side may be used). In another embodiment, a cathode inlet may also receive water, wherein the water may be supplied to the cathode inlet to cool the cell stack 12 during electrolysis.

The water supplied to the anodic inlet flows to an anodic inlet manifold that distributes the water to the anode side of the plurality of cells contained with the cell stack 12. In embodiments where water is supplied to the cathode inlet, water supplied to the cathode inlet flows to a cathodic inlet manifold that distributes the water to the cathode side of the plurality of cells in the cell stack 12. In certain examples, the amount of water (e.g., deionized (DI) water) transferred to or circulated through each cell of the stack may be in a range of 0.25-5 mL/Amp/cell/min.

During electrolysis, oxygen (O₂) is produced at the anode side of the electrolytic cells and hydrogen (H₂) is produced at the cathode side of the electrolytic cells. Specifically, a water splitting electrolysis reaction is configured to take place within each individual cell in the cell stack 12. Each cell includes one interface (the anode side of the cell) configured to run an oxygen evolution reaction (OER) and another interface (the cathode side of the cell) configured to run a hydrogen evolution reaction (HER) (such as depicted in FIG. 1B).

During electrolysis, some of the water supplied to the anode side of an electrolytic cell may not be converted into oxygen. Accordingly, a two-phase flow of oxygen and unreacted water is outlet from each of the anode sides of the cells into an anodic outlet manifold 13. The two-phase flow of oxygen and unreacted water flows from out of the cell stack 12 through the anodic outlet manifold 13. This stream within the anodic outlet manifold 13 may be configured to be transferred to a gas detection and conditioning system, such as described in greater detail below, for analysis of the composition within the stream. Specifically, this anodic stream may be analyzed to identify if any undesirable hydrogen gas has leaked (i.e., cross-leaked) across the membranes from the cathode sides of the cells to the anode sides of the cells within the cell stack.

Additionally, in some embodiments, water may be supplied to the cathode side of the cell stack as a coolant. Accordingly, a two-phase flow of hydrogen and water is outlet from each of the cathode sides of the cells to a cathodic outlet manifold 14. The two-phase flow of hydrogen and water flows out of the cell stack 12 through the cathodic outlet manifold 14. Similarly, this particular stream within the cathodic outlet manifold 14 may be configured to be transferred to a gas detection and conditioning system (separate from the anodic gas detection and conditioning system) for analysis of the composition within the stream. Specifically, this cathodic stream may be analyzed to identify if any undesirable oxygen gas has leaked (i.e., cross-leaked) across the membranes from the anode sides of the cells to the cathode sides of the cells within the cell stack.

FIG. 1B depicts an example of an electrochemical or electrolytic cell for hydrogen gas and oxygen gas production through the splitting of water. The electrochemical cell within FIG. 1B may be one of the plurality of cells within the electrochemical stack in FIG. 1A. The electrolytic cell includes a cathode, an anode, and a membrane positioned between the cathode and anode. The membrane may be a proton exchange membrane (PEM) that may have a catalyst coating on one or both surfaces of the PEM. In other examples, the membrane may be positioned within an electrochemical cell having a catalyst coating on an adjacent supporting layer within the cell (e.g., a gas diffusion layer or porous transport layer near or abutting the membrane).

Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂.

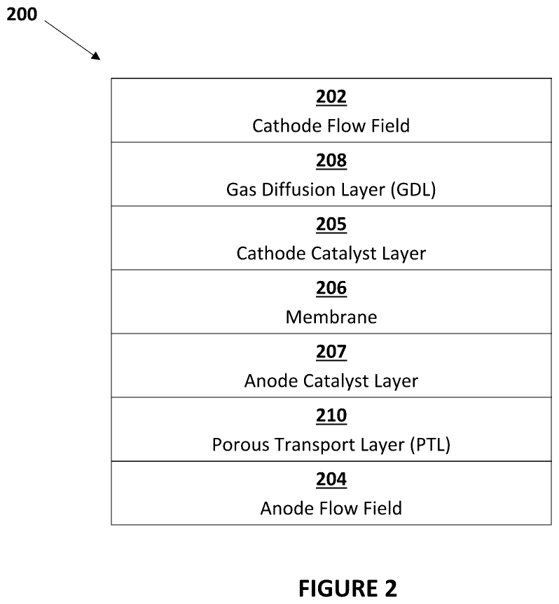

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers. The overall thickness (i.e., for all layers of the membrane combined including the catalyst coatings, if present) may be less than 1000 microns, less than 500 microns, less than 100 microns, less than 50 microns, less than 10 microns, less than 5 microns, less than 2 microns, less than 1 micron, in a range of 1-1000 microns, in a range of 2-500 microns, in a range of 5-100 microns, or in a range of 10-50 microns.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

In certain examples, the PTL is made from a titanium (Ti) mesh/felt. As used herein, a Ti mesh/felt may refer to a structure created from microporous Ti fibers. The Ti felt structure may be sintered together by fusing some of the fibers together. Ti felt may be made by a special laying process and a special ultra-high temperature vacuum sintering process. The Ti felt may have an excellent three-dimensional network, porous structure, high porosity, large surface area, uniform pore size distribution, special pressure, and corrosion resistance, and may be rolled and processed.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM.

Further, gaseous byproduct oxygen is configured to be removed from the PTL to the flow fields. In such an arrangement, liquid water functions as both reactant and coolant on the anode side of the cell.

The thickness of the PTL may be within a range of 100-1000 microns, for example. The thickness may affect the mass transport within the cell as well as the durability/deformability and electrical/thermal conductivity of the PTL. In other words, a thinner PTLs compared to thicker PTLs (e.g., 1 mm) may provide better mass transport.

However, when the PTL is too thin (e.g., less than 100 microns), the PTL may suffer from poor two phase flow effects as well. PTLs are less prone to deformation compared to GDLs. Thickness of PTLs may also affect lateral electron conduction resistance along the lands in between channels.

In some examples, an anode catalyst coating layer may be positioned between the anode 204 and the PTL.

The cathode 202 and anode 204 of the cell may individually include a flow field plate composed of metal, carbon, or a composite material having a set of channels machined, stamped, or etched into the plate to allow fluids to flow inward toward the membrane or out of the cell.

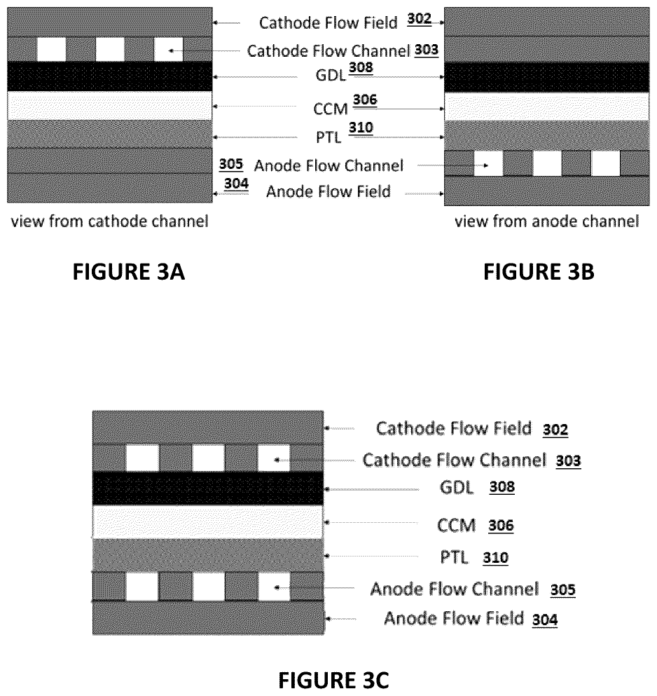

FIGS. 3A, 3B, and 3C depict examples of an electrochemical or electrolytic cell with flow fields. In these particular examples, the electrochemical cell includes a cathode flow field 302, cathode flow channels 303, an anode flow field 304, anode flow channels 305, and a membrane 306 positioned between the cathode and the anode. Additionally, the electrochemical cell 300 includes a gas diffusion layer 308 positioned between the catalyst coated membrane 306 and the cathode flow channels 303. Further, a porous transport layer 310 is positioned between the catalyst coated membrane 306 and the anode flow channels 305.

In the particular example depicted in FIGS. 3A and 3B, the cathode and anode flow fields are arranged to provide a cross-fluid flow. In such a cross-fluid arrangement, the fluid flow through the cathode flow channels is arranged perpendicular to the fluid flow through the anode flow channels. Specifically, FIG. 3A depicts the cross-sectional view of the electrochemical cell with the cathode flow channels displayed, while FIG. 3B depicts the cross-sectional view of the electrochemical cell rotated 90 degrees to display the anode flow channels.

In alternative examples, the flow fields may have a co-flow configuration or a counter-flow configuration. FIG. 3C depicts an alternative example, wherein the channels and lands of the anode flow field are parallel with the channels and lands of the cathode flow field. With the parallel arrangement, in a co-flow configuration, the flow of fluid through the anode flow field channels is in the same direction as the flow of fluid through the cathode flow field channels. Alternatively, a counter-flow configuration may be present with the parallel arrangement of the anode and cathode flow fields, wherein the flow of fluid through the anode flow field channels is in an opposite direction as the flow of fluid through the cathode flow field channels.

The orientation or configuration of fluid flow between the anode flow field and cathode flow field may be advantageous in adjusting or controlling the pressure distribution or temperature distribution within the electrochemical cell.

Regarding these anode and cathode flow fields depicted in FIGS. 3A and 3B, such flow fields may be configured to have paths of channels and land. The channels are configured for directing the flow of water and gas, while the lands are configured to contact an adjacent layer of the electrochemical cell (e.g., the GDL or PTL) providing electrical contact. FIGS. 3A and 3B depict examples of cells having three cathode flow channels and three anode flow channels, respectively. The number of flow channels are depicted for simplicity of a design, and in potential commercial use, may include many more flow channels. As such, the disclosure is not limited to such configurations as depicted in FIGS. 3A and 3B.

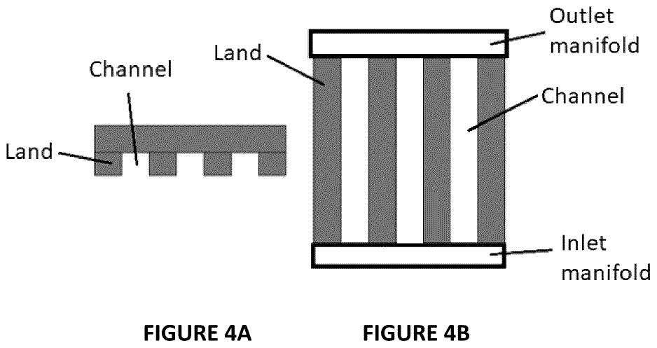

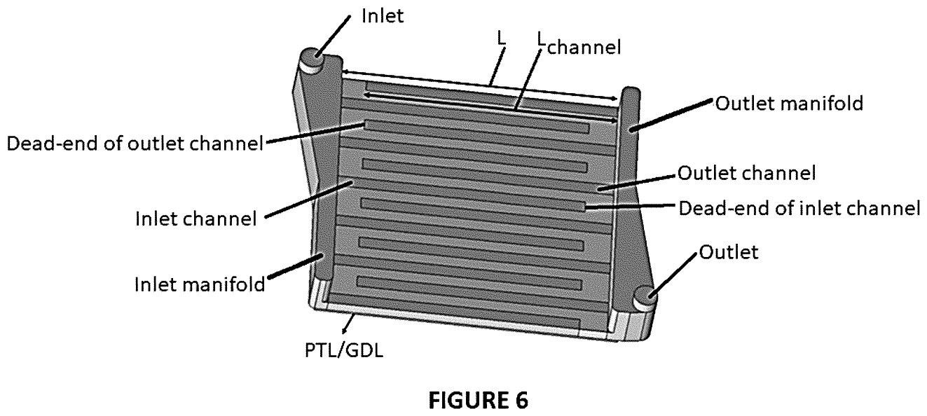

FIGS. 4A and 4B depict a side view and a top view, respectively, of such an electrode flow field having a plurality of channels and lands positioned between inlet and outlet manifolds (or plenums). In this particular example, the flow field includes 3 parallel channels and 4 lands, wherein each channel is positioned between adjacent lands. In this example, the plenums are depicted in a rectangular configuration for illustration purposes only. In practice, the manifold or plenum configuration would be in a different shape for improved fluid flow characteristics (see, e.g., FIG. 6).

There are challenges with how the flow field is arranged within an electrochemical cell, such as the arrangement depicted in FIGS. 4A and 4B. Specifically, challenges exist with providing optimal fluid flow and heat distribution within the cell to provide better performance and reduce risks of hotspots. The cell performance and durability depends on the flow configuration, in particular, at high current densities. Flow field designs that lead to poor liquid reactant supply to the catalyst layers suffer from mass transport overpotential. Transport overpotentials increase with increasing current density which is simultaneously accompanied with increasing cell temperature due to the additional heat dissipation due to increased transport overpotential. Ensuring sufficient reactant flow rate is necessary to minimize mass transport losses and avoid cell failures, especially for higher current density operations.

Additionally, inadequate liquid reactant flow in porous layers may lead to an accumulation of generated gas. Flow field design is therefore important in achieving sufficient water flow for gas removal to prevent dehydration issues. Increasing flow rate improves gas-liquid exchange in the porous layers, but also increases the pumping power cost and downstream separation costs due to larger sized equipment to deal with the increased volume. Nevertheless, increasing the flow rate in conventional flow fields such as those involving parallel channels connecting inlet and outlet plenums (manifolds) does not guarantee sufficient flow rates in porous layers for effective gas removal, in particular for high current density operations.

Furthermore, increasing the current density for a fixed flow rate may lead to significant increases in the gas fractions inside the porous transport layers. This increase in gas fraction occurs concurrently with the increase in mass transport overpotential. As used herein, “stoic ratio” is a non-dimensional metric comparing amount of liquid water supply with respect to the operational current density. An ideal stoic ratio provides sufficient water supply for the electrolysis reaction and effective gas removal. Below a critical stoic ratio, the rate of gas generation exceeds the rate of gas removal, which hinders the reactant liquid water from reaching the reaction sites. Even at low gas fractions, if the bubbles remain stagnant as opposed to a dynamic regime, local hot spots may arise. Therefore, having a design that achieves a threshold stoic ratio is important in mitigating increasing cell temperatures. Stoic ratio also depends on cell hardware and flow field geometry. Designs facilitating reduction in stoic ratio is important not only for cell performance but also from balance of plant perspective. Also, lower water flow rates allow for lower pumping and auxiliary/separation unit sizing for the plant design, therein helping reduce green hydrogen cost.

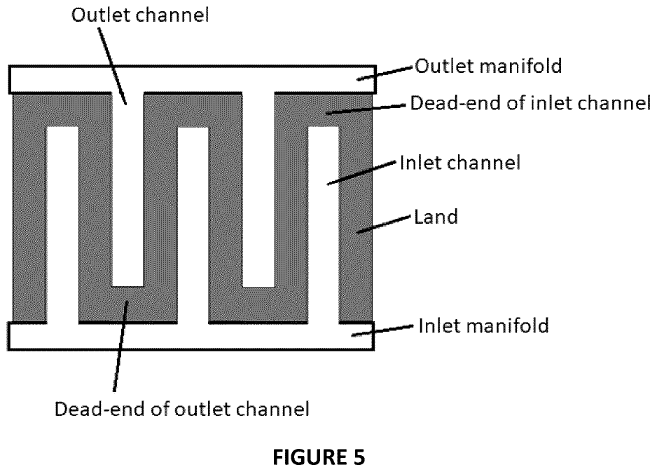

FIG. 5 depicts one embodiment of an improved flow field design aimed to address the challenges identified above. In this embodiment, the flow field includes a plurality of interdigitated, dead-end channels that are fluidically connected with the adjacent porous transport layer or gas diffusion layer. As depicted in FIG. 5, the flow field (on the anode and/or cathode side of the cell) has an inlet for water to flow into the flow field from an outside source. The flow field also includes an outlet configured to transport water and any hydrogen gas (cathode) or oxygen gas (anode) produced in the water splitting reaction at the membrane.

The flow field additionally includes a plurality of dead-end channels only connected to the inlet, as well as an additional plurality of dead-end channels only connected to the outlet. In this particular example, there are 3 inlet channels and 2 outlet channels. The number of flow channels are depicted for simplicity of a design, and in potential commercial use, may include many more flow channels. As such, the disclosure is not limited to such a configuration as depicted in FIG. 5.

In this configuration, water is configured to flow into each of the inlet channels. Each inlet channel has an opening on the inlet side to receive the water flow. Additionally, each channel is defined by three walls or surfaces on the sides of the channel running perpendicular to the direction of the inlet segment. The first wall of the channel is formed by the planar outer surface of the flow field, on the opposite surface from the PTL or GDL.

The additional two walls are formed by the lands of the flow field that extend toward and abut the adjacent layer of the electrochemical cell (e.g., the PTL or GDL). The fourth “surface” of the channel is open, and abuts the adjacent PTL or GDL, allowing fluid to flow into the PTL/GDL.

The dead-end design of each of these inlet channels is formed by a truncation of each channel prior to a connection with the outlet of the flow field, therein not providing a direct fluid connection with the outlet of the flow field. This advantageously forces the water to flow down into the adjacent porous layer of the cell (e.g., the PTL or GDL) instead of directly from the inlet to the outlet of the flow field without flowing into the adjacent layer.

Within the configuration depicted in FIG. 5, the design of each dead-end outlet channel may be similar to the dead-end inlet channels. Fluid flow (e.g., water and hydrogen or oxygen gas) is configured to flow out from the PTL or GDL into each of the outlet channels. Each outlet channel has an opening on the outlet side to receive the fluid flow.

Similar to the inlet channels, each outlet channel is defined by three walls or surfaces on the sides of the channel running perpendicular to the direction of the outlet segment. The first wall of the channel is formed by the planar outer surface of the flow field, on the opposite surface from the PTL or GDL. The additional two walls are formed by the lands of the flow field that extend toward and abut the adjacent layer of the electrochemical cell (e.g., the PTL or GDL). The fourth “surface” of the channel is open, and abuts the adjacent PTL or GDL, allowing fluid to flow from the PTL/GDL into the outlet channel.

Due to the dead-end design of each outlet channel, each outlet channel is truncated prior to connecting with the inlet of the flow field, therein not providing a direct fluid connection with the inlet of the flow field. This advantageously helps create a pressure differential between the inlet and the outlet of the flow field. In other words, the flow of water into the dead-end inlet channels may create a pressure build-up on the inlet side that forces or helps redirect the flow of the water into the PTL or GDL, while the outlet side of the flow field may be open to atmospheric pressure conditions or controlled at a certain back pressure. This pressure differential is advantageous in assisting the redirection of flow from the PTL/GDL to the outlet channels and outlet of the flow field.

Furthermore, fluid flow through porous media (such as a porous PTL or GDL) increases the overall pressure drop. For example, in a 5 cm² active area cell having 1 mm wide and 1 mm deep channels separated by 1 mm land width, the trade-off is 3.5 times higher pressure drop for a 2.2 times better heat removal capability. The pressure drop-heat transfer coefficient trade-off may be dependent on porous layer permeability dictated by porosity and pore size, channel dimensions and channel width/land width sensitivity, as well as overall dead-end channel length.

In such an arrangement, water flowing in the dead-end inlet channels is forced into the adjacent porous layer underneath the land areas in order to reach the outlet flow channels. This advantageously increases the velocity of water within the PTL or GDL by one or two orders of magnitude (e.g., 10 times, 100 times, 200 times, or 215 times higher), compared to a similarly configured flow field with regular channels, where the main transport mechanism is diffusion/permeation of water. In other words, a dead-end channel flow field configuration may alter the main transport mechanism to forced convection.

This advantageously can improve or increase the fluid flow velocity within the PTL/GDL on the order of millimeters/second versus micrometers/second flow speed in current state-of-the-art flow fields.

Furthermore, convective flow within the PTL/GDL may also advantageously aid in the removal of generated gas and replenish the CCM with water at the operating temperature, thereby enhancing heat removal. That is, the improved flow of water into and within the PTL/GDL may allow for improved heat exchange with reactants near the CCM, as well as reduced chance of hot spots within the cell.

Additional advantages of a dead-end design include that less water flow may be needed for the same performance output. That is, the stoic ratio between water flow and operating current within the electrochemical cell may be lowered while still being able to maintain the operating efficiency of the cell (e.g., removal of the generated hydrogen and oxygen gases from the water splitting reaction). With a lower inlet water requirement, this advantageously allows for the downsizing of downstream equipment needed to separate the water and gases produced within the electrochemical cell. For example, a smaller gas-liquid separator would be needed to separate the water and oxygen gas produced on the anode side of the cell. Additionally, a smaller gas-liquid separator would be required on the cathode side of the cell to separate hydrogen gas and water. These smaller separators, piping, pumps, etc. result in smaller operating costs in comparison to a similarly sized electrochemical cell/stack without the improved flow fields described herein.

Heat dissipated from the cell stemming from inefficiencies may result in an increase in the temperature at the membrane. Therefore, an additional advantage of a dead-end configuration as disclosed herein includes that less water flow may be needed for the same heat removal capacity. That is, the membrane may be controlled at a desired temperature with less water flow. With a lower inlet water requirement for cooling, this advantageously allows for the downsizing of downstream equipment such as plant heat exchangers and pumps.

In the configuration depicted in FIG. 5, each dead-end channel within the flow field is arranged to alternate between an inlet channel and an outlet channel. This may be advantageous in providing an optimal flow through the adjacent PTL/GDL. Nonetheless, alternative configurations are possible to provide potential flow advantages or optimal pressure differentials within the cell. In one example, not every channel within the flow field may be a dead-end channel. In certain cases, at least one channel in the flow field is a dead-end inlet channel. Further, in some cases, at least one channel is a dead-end outlet channel. In other embodiments, at least 10%, at least 20%, at least 30%, at least 40%, at least 50%, at least 60%, at least 70%, at least 80%, or at least 90% of each inlet or outlet channel is a dead-end inlet or outlet channel. In other embodiments, every channel in the flow field is either a dead-end inlet channel or a dead-end outlet channel.

In certain embodiments, the dimensions (e.g., the length, width, and/or depth) of the inlet channels and inlet lands may be the same as the dimensions of the outlet channels and outlet lands. Alternatively, the dimensions (e.g., the length, width, and/or depth) of the inlet channels and/or inlet lands may be different from the dimensions of the outlet channels and/or lands.

Further, in certain embodiments, the dimensions for the anode flow field (e.g., the inlet channel and inlet land dimension) may be the same as the dimensions for the outlet flow field. Alternatively, the dimensions for the anode flow field may be different from the dimensions for the outlet flow field. For example, in certain examples, the anode flow field may be configured with dead-end inlet channels and dead-end outlet channels as disclosed herein, while the cathode flow field may be configured with conventional inlet/outlet channels extending the entire length between the inlet manifold and outlet manifold. Alternatively, in other examples, the cathode flow field may be configured with dead-end inlet channels and dead-end outlet channels as disclosed herein, while the anode flow field may be configured with conventional inlet/outlet channels extending the entire length between the inlet manifold and outlet manifold.

In some examples, there may be an imbalance or offset between the number of dead-end inlet channels and dead-end outlet channels within the flow field configuration. In one case, the ratio of inlet to outlet channels may be greater than 1:1 (e.g., 2:1 or 3:1). For instance, two dead-end inlet channels may be positioned adjacent to each other, followed by one dead-end outlet channel, followed by two more adjacent dead-end inlet channels, and so on. In other words, additional arrangements of dead-end inlet channels and dead-end outlet channels are possible and are not limited to the embodiment depicted in FIG. 5.

These dead-end inlet and outlet channels may be fabricated by a variety of different methods, such as etching or carving out grooves within a metal flow field plate to form the channels of the flow field. In certain examples, the metal plate may be a titanium plate. Following the etching, the etched surface of the plate may be coated with platinum or gold to protect the underlying titanium surface from corrosion.

FIG. 6 depicts a projection view of an additional embodiment of an improved flow field design. Similar to the example depicted in FIG. 5, the flow field configuration in FIG. 6 includes a plurality of interdigitated, dead-end channels. In this example, the flow field (e.g., for the anode or cathode side of the electrochemical cell) includes an inlet for water to flow into the flow field from an outside source. The flow field also includes an outlet configured to transport water and any hydrogen gas (cathode side) or oxygen gas (anode side) produced in the water splitting reaction at the membrane. Further, the flow field additionally includes a plurality of dead-end channels only connected to the inlet, as well as an additional plurality of dead-end channels only connected to the outlet. In this particular example, there are 6 inlet channels and 6 outlet channels. The number of flow channels within this example are depicted for simplicity of a design, and in potential commercial use, may include many more flow channels. As such, the disclosure is not limited to such a configuration as depicted in FIG. 6.

In the configuration depicted in FIG. 6, each dead-end channel within the flow field is arranged to alternate between an inlet channel and an outlet channel. This may be advantageous in providing an optimal flow through the adjacent PTL/GDL. Nonetheless, as noted above, alternative configurations are possible to provide potential flow advantages or optimal pressure differentials within the cell.

Further, the length of each dead-end inlet channel and/or dead-end outlet channel may be also modified to be configured for the optimal fluid flow through the adjacent PTL/GDL. In other words, the overall length of each dead-end channel (L_{channel}) in relation to the overall length of the flow field (L) may be modified. In certain examples, the ratio of L_{channel} to L is at least 0.5:1, at least 0.6:1, at least 0.7:1, at least 0.8:1, or at least 0.9:1, and less than 1:1. In other examples, the ratio of L_{channel} to L is in a range between 0.5:1 to 1:1, 0.6:1 to 1:1, 0.7:1 to 1:1, 0.8:1 to 1:1, or 0.9:1 to 1:1. The ratio of L_{channel} to L may also be important in tailoring internal cell thermal profile as a L_{channel}/L<1 advantageously provides additional heat conduction paths through the flow plate.

In certain examples, the length of each dead-end inlet channel and each dead-end outlet channel is the same. In other examples, the lengths of each dead-end inlet channel are the same, the lengths of each dead-end outlet channel are the same, but the inlet channel lengths differ from the outlet channel lengths. In yet other examples, each individual dead-end inlet channel and dead-end outlet channel may have its own length that differs from each additional channel. This may be advantageous in controlling the overall fluid flow into the adjacent PTL/GDL in such a way to be as uniform as possible. For instance, the pressure differential between inlet and outlet channels may be different in certain areas of the cell if all inlet and outlet channels were of a uniform length. By modifying the lengths to be different in various areas of the cell (e.g., outer areas vs. central areas of the cell), the pressure differentials may be made more uniform, to therein provide a more uniform fluid flow into the PTL/GDL across the entire layer.

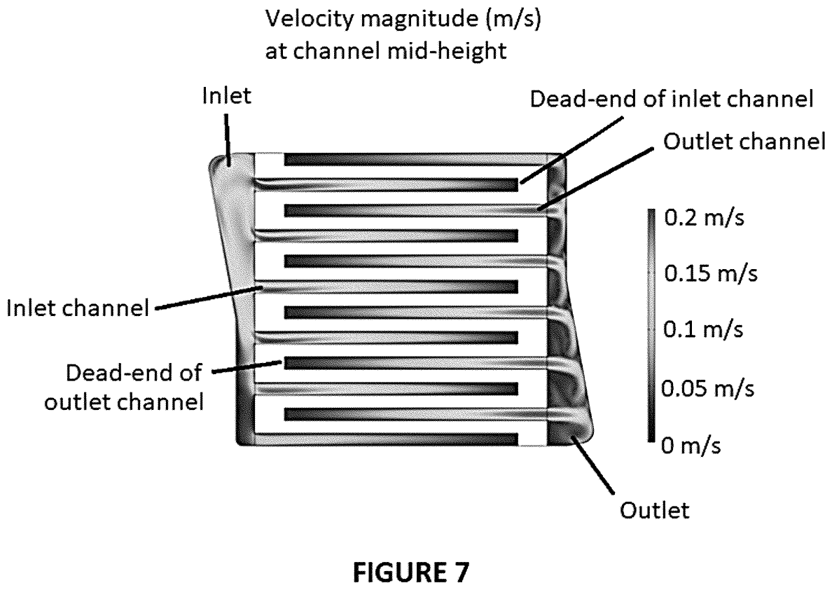

FIG. 7 depicts an example of fluid flow velocities through the dead-end inlet and outlet channels based on the flow field configuration exemplified in FIG. 6. In this example, water is input into the inlet of the flow field and is distributed into the six dead-end inlet channels. As identified in the figure, the flow at the entrance of a majority of the inlet channels is higher (e.g., greater than 0.2 m/s) than near the dead-end of each channel (e.g., less than 0.05 m/s). Due to the inclusion or addition of dead-end channels, water is forced to flow into the adjacent layer of the electrochemical cell (e.g., the PTL or GDL), as opposed to bypassing the adjacent layer directly to the outlet channels of the flow field. As further identified in FIG. 7, the velocity of the fluid flow exiting the flow field through the outlet channels is also greater than 0.2 m/s near the end of the majority of the outlet channels.

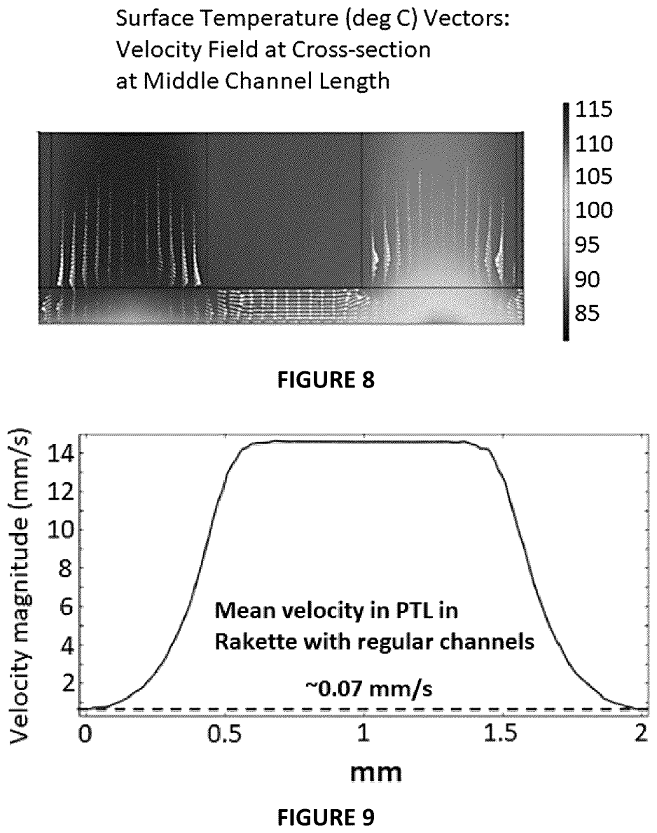

FIG. 8 depicts an additional example of fluid flow velocities and temperature distribution within the various flow field channels and the adjacent PTL or GDL. An excerpt of the flow field is depicted for three sections of the flow field, as well as the underlying PTL/GDL. On the left side of the excerpt is an inlet channel. In the middle of the excerpt is a land area of the flow field. On the right of the excerpt is an outlet channel.

The white arrows within the excerpt show the fluid flow through the flow field and adjacent layer of the cell. Fluid (water) flows through the dead-end inlet channel to be forced or redirected down underneath the channel into the adjacent PTL/GDL. As noted above, due to the pressure differential created between inlet and outlet channels, the fluid is directed toward the outlet channel, travelling within the PTL/GDL underneath the land of the flow field. Subsequently, the water and collected gas products (e.g., hydrogen or oxygen) within the PTL/GDL flow out through the outlet channel.

As depicted in FIG. 8, due to the exothermic nature of the water splitting reaction, water flowing into the PTL/GDL removes some to all of the heat generated from the reaction. This is identified by the hotter temperatures seen in and below the outlet channel of the flow field on the right side of the excerpt. As noted above, the dead-end configuration of the inlet and outlet channels within the flow field is advantageous in providing an improved mechanism for heat exchange as the cooler inlet water is forced to flow into the adjacent cell layer, allowing for a more efficient heat exchange over the current state-of-the art.

FIG. 9 depicts an additional improvement of the dead-end configuration of inlet and outlet channels within the flow field. As mentioned above, due to the restrictions provided by dead-end channels, fluid is forced into the adjacent cell layer. This improves the velocity of the fluid flow within the adjacent layer (e.g., PTL/GDL). As depicted in FIG. 9, the dashed line represents the current state-of-the-art configuration, wherein fluid flow through the PTL or GDL is low, on the order of micrometer/s. Through the addition of restrictions of fluid flow from the dead-end arrangements, the fluid flow may be increased from 0.07 mm/s to 15 mm/s within certain areas of the PTL/GDL. This equates to approximately 215 times the velocity of the current state-of-the-art. As noted above, this higher flow may advantageously allow for improved removal of the generated gases from the water splitting reaction as well as enhancing heat removal.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A flow field for an electrochemical cell, the flow field comprising:
an inlet configured to receive water;
a plurality of inlet channels, each inlet channel connected to the inlet and configured to transfer water from the inlet to an adjacent layer of the electrochemical cell;
an outlet configured to transfer fluids out of the electrochemical cell;
a plurality of outlet channels, each outlet channel connected to the outlet and configured to transfer the fluids from the adjacent layer of the electrochemical cell to the outlet; and
a plurality of lands, each land separating a channel of the plurality of inlet channels and the plurality of outlet channels from an additional channel of the plurality of inlet channels and the plurality of outlet channels,
wherein at least one inlet channel of the plurality of inlet channels is a dead-end inlet channel such that the at least one inlet channel does not extend an entire length from the inlet to the outlet of the flow field and therein does not provide a direct fluid connection with the outlet,
wherein at least one outlet channel of the plurality of outlet channels is a dead-end outlet channel such that the at least one outlet channel does not extend the entire length from the inlet to the outlet of the flow field and therein does not provide a direct fluid connection with the inlet, and
wherein the dead-end inlet channel and the dead-end outlet channel are configured to redirect more water into the adjacent layer of the electrochemical cell in comparison to an electrochemical cell without any dead-end inlet channels and dead-end outlet channels.

2. The flow field of claim 1, wherein the adjacent layer is a porous transport layer.

3. The flow field of claim 1, wherein the adjacent layer is a gas diffusion layer.

4. The flow field of claim 1, wherein every inlet channel of the plurality of inlet channels is a dead-end inlet channel.

5. The flow field of claim 1, wherein every outlet channel of the plurality of outlet channels is a dead-end outlet channel.

6. The flow field of claim 1, wherein a ratio of a length of the at least one inlet channel to an overall length of the flow field as measured from the inlet to the outlet is in a range between 0.5:1 to 1:1, and
wherein a ratio of a length of the at least one outlet channel to the overall length of the flow field as measured from the inlet to the outlet is in a range between 0.5:1 to 1:1.

7.-8. (canceled)

9. The flow field of claim 1, wherein a flow rate of the water into the adjacent layer of the electrochemical cell is at least 10 times higher in comparison to the electrochemical cell without any dead-end inlet channels and dead-end outlet channels.

10. The flow field of claim 1, wherein the dead-end inlet channel and the dead-end outlet channel are configured to provide an improved heat exchange with reactants near a membrane of the electrochemical cell using a lower volume of water in comparison to the electrochemical cell without any dead-end inlet channels and dead-end outlet channels.

11. (canceled)

12. The flow field of claim 1, wherein the flow field, when positioned within the electrochemical cell, is configured to operate with 200 mV or less of pure resistive loss when operating at a current density of at least 3 Amp/cm².

13. The flow field of claim 1, wherein the flow field, when positioned within the electrochemical cell, is configured to transfer 0.25-5 ml of water through the electrochemical cell per Amp per min.

14. An electrochemical cell comprising:
a flow field;
a membrane; and
a porous transport layer or a gas diffusion layer positioned between the flow field and the membrane,
wherein the flow field comprises:
an inlet configured to receive water;
a plurality of inlet channels, each inlet channel connected to the inlet and configured to transfer water from the inlet to the porous transport layer or the gas diffusion layer;
an outlet configured to transfer fluids out of the electrochemical cell;
a plurality of outlet channels, each outlet channel connected to the outlet and configured to transfer the fluids from the porous transport layer or the gas diffusion layer to the outlet; and
a plurality of lands, each land separating a channel of the plurality of inlet channels and the plurality of outlet channels from an additional channel of the plurality of inlet channels and the plurality of outlet channels,
wherein at least one inlet channel of the plurality of inlet channels is a dead-end inlet channel such that the at least one inlet channel does not extend an entire length from the inlet to the outlet of the flow field and therein does not provide a direct fluid connection with the outlet,
wherein at least one outlet channel of the plurality of outlet channels is a dead-end outlet channel such that the at least one outlet channel does not extend the entire length from the inlet to the outlet of the flow field and therein does not provide a direct fluid connection with the inlet, and
wherein the dead-end inlet channel and the dead-end outlet channel are configured to redirect more water into the porous transport layer or the gas diffusion layer in comparison to an electrochemical cell without any dead-end inlet channels and dead-end outlet channels.

15.-16. (canceled)

17. The electrochemical cell of claim 14, wherein every inlet channel of the plurality of inlet channels is a dead-end inlet channel.

18. The electrochemical cell of claim 14, wherein every outlet channel of the plurality of outlet channels is a dead-end outlet channel.

19. The electrochemical cell of claim 14, wherein a ratio of a length of the at least one inlet channel to an overall length of the flow field as measured from the inlet to the outlet is in a range between 0.5:1 to 1:1, and
wherein a ratio of a length of the at least one outlet channel to the overall length of the flow field as measured from the inlet to the outlet is in a range between 0.5:1 to 1:1.

22. The electrochemical cell of claim 14, wherein a flow rate of the water into the porous transport layer or the gas diffusion layer is at least 10 times higher in comparison to the electrochemical cell without any dead-end inlet channels and dead-end outlet channels.

23. The electrochemical cell of claim 14, wherein the dead-end inlet channel and the dead-end outlet channel are configured to provide an improved heat exchange with reactants near the membrane of the electrochemical cell using a lower volume of water in comparison to an electrochemical cell without any dead-end inlet channels and dead-end outlet channels.

24. (canceled)

25. The electrochemical cell of claim 14, wherein the electrochemical cell is configured to operate with 200 mV or less of pure resistive loss when operating at a current density of at least 3 Amp/cm².

26. The electrochemical cell of claim 14, wherein the electrochemical cell is configured to transfer 0.25-5 mL of water through the electrochemical cell per Amp per min.

27. The flow field of claim 1, wherein a ratio between a number of dead-end inlet channels of the plurality of inlet channels to a number of dead-end outlet channels of the plurality of outlet channels in the flow field is greater than 1:1.

28. The flow field of claim 1, wherein a ratio between a number of dead-end inlet channels of the plurality of inlet channels to a number of dead-end outlet channels of the plurality of outlet channels in the flow field is at least 2:1, and
wherein at least two dead-end inlet channels are positioned adjacent to each other and separated from at least two additional dead-end inlet channels by one dead-end outlet channel.
